(19) United States
(12) Patent Application Publication
(10) Pub. No.: US 2021/0097447 A1
(43) Pub. Date: Apr. 1, 2021

(54) Computer System and Method for Supporting Model Selection

(71) Applicant: Hitachi, Ltd., Tokyo (JP)

(72) Inventors: Toshihiko KASHIYAMA, Tokyo (JP); Tsunehiko BABA, Tokyo (JP)

(21) Appl. No.: 17/027,843

(22) Filed: Sep. 22, 2020

(30) Foreign Application Priority Data
Oct. 1, 2019 (JP) 2019-181370

(51) Int. Cl. G06N 20/20; G06F 16/901; G06F 11/30

(52) U.S. Cl. CPC G06N 20/20; G06F 11/3086; G06F 16/9024

(57) ABSTRACT

The disclosure is to present quantitative information for evaluating model transparency. A computer configured to support selection of a model generated by machine learning includes a transparency score calculation unit configured to execute analysis processing for analyzing traceability of a generation process of a target model, and calculate a transparency score indicating a degree of the traceability of the generation process of the target model based on a result of the analysis processing, and a report generation unit configured to generate a report for presenting the transparency score.

### CLAIM OF PRIORITY

The present application claims priority from Japanese patent application JP 2019-181370 filed on Oct. 1, 2019, the content of which is hereby incorporated by reference into this application.

### BACKGROUND OF THE INVENTION

### 1. Field of the Invention

The present invention relates to a technique for supporting model selection.

### 2. Description of the Related Art

Models generated by machine learning have been utilized in a variety of fields, such as medical and manufacturing industries. In addition, opportunities for using transfer learning by reusing an existing model to generate a new model and the like are increasing.

Various models are provided depending on purposes of use, accuracy, data to be handled, and the like. A user selects a model that matches a request from a plurality of models. For example, the user selects a model having high accuracy. In recent years, due to AI ethics issues, there are cases where models are selected based on explainability, transparency, and fairness thereof.

A method of using a model card described in Margaret Mitchell, 8 others, “Model Cards for Model Reporting”, FAT* '19: Conference on Fairness, Accountability, and Transparency, Jan. 29-31, 2019, Atlanta, Ga., USA (Non-Patent Literature 1) as information that supports the model selection is conceivable. Non-Patent Literature 1 discloses that information related to a model such as benchmark evaluation is included in the model card.

The model card disclosed in Non-Patent Literature 1 needs to be manually set up. Also, no model card provides quantitative information. Thus, in order to select a model based on the model card, the user needs to have experience and knowledge.

### SUMMARY OF THE INVENTION

An object of the invention is to provide a system and a method capable of presenting quantitative information for evaluating transparency of a model when a model is to be selected with the model transparency as a standard.

A representative example of the invention disclosed in the present application is as follows. That is, a computer system configured to support selection of a model generated by machine learning includes: at least one computer including a processor and a memory; a transparency score calculation unit configured to execute analysis processing for analyzing traceability of a generation process of a target model, and calculate a transparency score indicating a degree of the traceability of the generation process of the target model based on a result of the analysis processing of the generation process of the target model; and a report generation unit configured to generate a report for presenting the transparency score.

According to the invention, a transparency score can be presented as quantitative information for evaluating model transparency. Problems, configurations and effects other than those described above will be clarified by the description of following embodiments.

### BRIEF DESCRIPTION OF THE DRAWINGS

FIG. 1 is a diagram showing a configuration example of a computer system according to a first embodiment.

FIG. 2 is a diagram showing an example of a data structure of connection system management information according to the first embodiment.

FIG. 3 is a diagram showing an example of a data structure of link management information according to the first embodiment.

FIG. 4 is a diagram showing an example of a data structure of lineage management information according to the first embodiment.

FIG. 5 is a diagram showing an example of a data structure of transparency score management information according to the first embodiment.

FIG. 6 is a flowchart illustrating an example of data collection processing executed by a model selection support apparatus according to the first embodiment.

FIG. 7 is a flowchart illustrating an example of transparency score report generation processing executed by the model selection support apparatus according to the first embodiment.

FIG. 8A is a diagram showing an example of a screen presented by the model selection support apparatus according to the first embodiment.

FIG. 8B is a diagram showing an example of the screen presented by the model selection support apparatus according to the first embodiment.

FIG. 9 is a diagram showing an example of a data structure of the transparency score management information according to the first embodiment according to a second embodiment.

FIG. 10 is a diagram showing an example of a screen presented by a model selection support apparatus according to the second embodiment.

FIG. 11 is a diagram showing an example of a data structure of lineage management information according to a third embodiment.

FIG. 12 is a diagram showing an example of a data structure of the transparency score management information according to the first embodiment according to the third embodiment.

FIG. 13 is a flowchart illustrating an example of transparency score update processing executed by a model selection support apparatus according to the third embodiment.

FIG. 14A is a diagram showing an example of a screen presented by the model selection support apparatus according to the third embodiment.

FIG. 14B is a diagram showing an example of the screen presented by the model selection support apparatus according to the third embodiment.

### DESCRIPTION OF THE PREFERRED EMBODIMENTS

Embodiments of the invention will be described below with reference to drawings. However, the invention should not be construed as being limited to the description of the embodiment described below. Those skilled in the art could have easily understood that specific configurations can be changed without departing from the spirit or scope of the invention.

In configurations of the invention described below, the same or similar configurations or functions are denoted by same reference numerals, and a repeated description thereof is omitted.

In the present description, expressions such as “first”, “second”, and “third” are used to identify components, and do not necessarily limit the number or order.

### First Embodiment

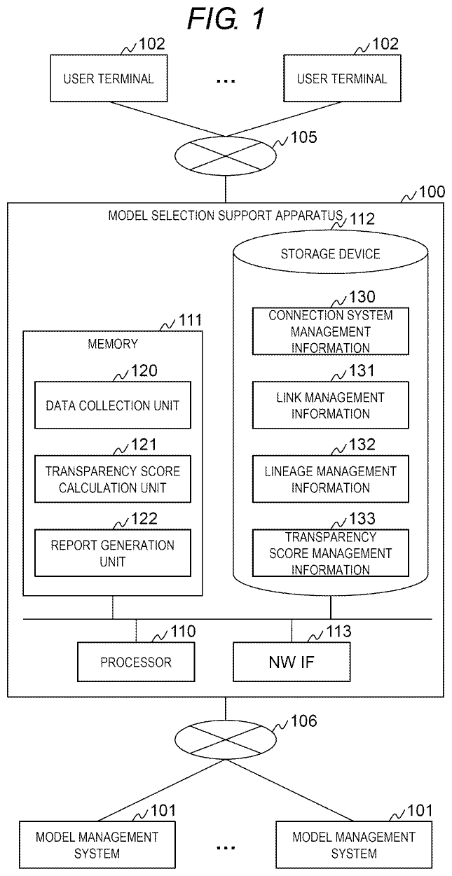

FIG. 1 is a diagram showing a configuration example of a computer system according to a first embodiment.

The computer system includes a model selection support apparatus 100, a plurality of model management systems 101, and a plurality of user terminals 102. The model selection support apparatus 100 and the user terminals 102 are connected via a network 105. The model selection support apparatus 100 and the model management systems 101 are connected via a network 106. The networks 105 and 106 are, for example, a wide area network (WAN) and a local area network (LAN). A connection method of the networks 105 and 106 may be either wired or wireless. The invention is not limited by the number of model management systems 101 and user terminals 102 included in the computer system.

The model management system 101 is a system operated by a provider or a developer of a model. The model management system 101 includes a system that manages a model, data used for model generation (input data), a program used for the model generation, data used for model verification (verification data), and a program used for the model verification, and a verification result, and the like. The model management system 101 also includes a system that manages a model lineage, a system that manages a model catalog, and a system that manages a program catalog. The system that manages various kinds of information includes at least one computer.

Here, the model lineage (history) is information for grasping a flow related to input and output of a model generation process such as data input, data processing, model generation, and model verification. In other words, the model lineage is information for tracking a model generation process. The model lineage manages a relevance of data and programs used in the model generation process and processing results.

The user terminal 102 is a terminal operated by a user who uses the model. The terminal includes a processor, a memory, a network interface, an input device, and an output device (which are not shown). The input device is a keyboard, a mouse, a touch panel, or the like. The output device is a display or the like.

The model selection support apparatus 100 is a computer that presents quantitative information for evaluating model transparency. In the present embodiment, a transparency score indicating a degree of traceability of the model generation process is presented as the quantitative information for evaluating the model transparency. Functions of the model selection support apparatus 100 may be implemented by using a model selection support system including a plurality of computers.

The traceability of the model generation process is defined herein as the model transparency.

The model selection support apparatus 100 includes a processor 110, a memory 111, a storage device 112, and a network interface 113. Hardware components are connected to each other via a bus. The model selection support apparatus 100 may include an input device and an output device.

The processor 110 executes a program stored in the memory 111. The processor 110 operates as a functional unit (module) that implements specific functions by executing processing in accordance with the program. In the following description, when the processing is described using the functional unit as the subject, it is indicated that the processor 110 executes the program that implements the functional unit.

The memory 111 stores the program executed by the processor 110 and information used by the program. The memory 111 includes a work area temporarily used by the program. The program stored in the memory 111 will be described below.

The storage device 112 is a hard disk drive (HDD), a solid state drive (SSD), or the like, and stores data permanently. The data stored in the storage device 112 will be described below.

The network interface 113 is an interface for communicating with an external apparatus via a network.

Here, the program stored in the memory 111 and the data stored in the storage device 112 will be described.

The memory 111 stores programs for implementing a data collection unit 120, a transparency score calculation unit 121, and a report generation unit 122. The programs stored in the memory 111 may be stored in the storage device 112. In this case, the processor 110 reads the programs from the storage device 112 and loads the programs into the memory 111.

The data collection unit 120 acquires information related to a model from the model management system 101. The transparency score calculation unit 121 analyzes the traceability of the model generation process and calculates a model transparency score based on an analysis result. The report generation unit 122 generates a report including the transparency score and the like.

For each functional unit included in the model selection support apparatus 100, a plurality of functional units may be integrated into one functional unit, or one functional unit may be divided into a plurality of functional units for each function. For example, the transparency score calculation unit 121 may include the function of the report generation unit 122.

The storage device 112 stores connection system management information 130, link management information 131, lineage management information 132, and transparency score management information 133.

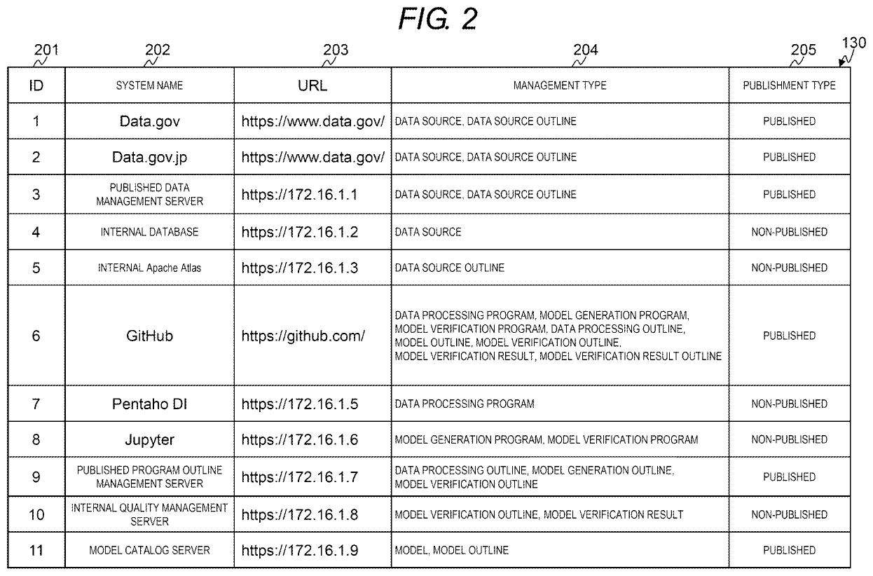

The connection system management information 130 is information for managing a system as a data collection destination. A data structure of the connection system management information 130 will be described in detail with reference to FIG. 2.

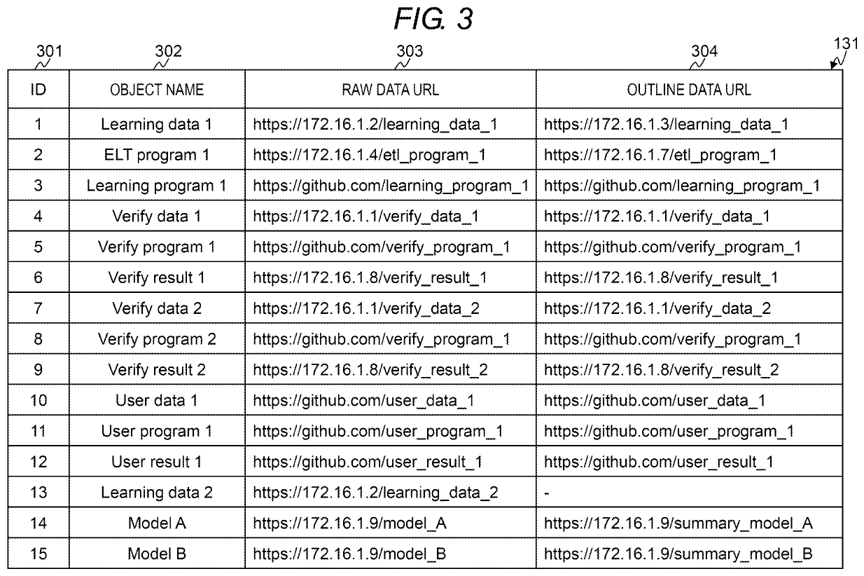

The link management information 131 is information for managing a link for accessing a system that manages data, programs, models, and the like. A data structure of the link management information 131 will be described in detail with reference to FIG. 3. In the present embodiment, the data and the programs used in the model generation process, the processing results, and the like are referred to as objects.

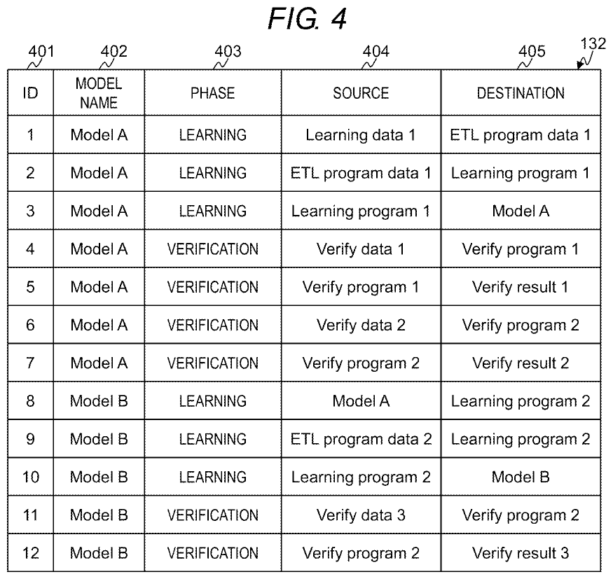

The lineage management information 132 is information for managing a model lineage. A data structure of the lineage management information 132 will be described in detail with reference to FIG. 4.

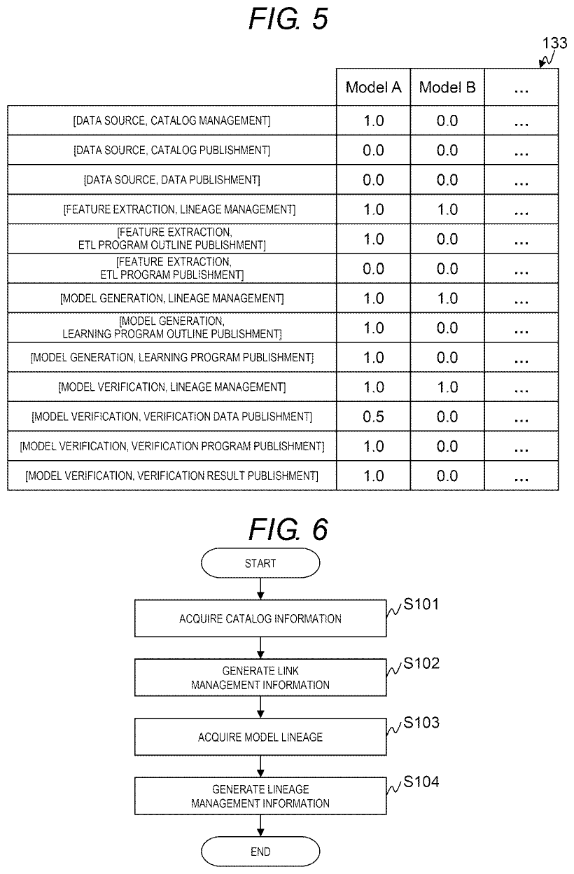

The transparency score management information 133 is information for managing information related to the transparency score calculated by the transparency score calculation unit 121. A data structure of the transparency score management information 133 will be described in detail with reference to FIG. 5.

All or part of the information stored in the storage device 112 may be stored in the memory 111.

Although the model selection support apparatus 100 is independent from the model management system 101 in FIG. 1, the model selection support apparatus 100 may be included in the model management system 101. Further, the model selection support apparatus 100 may be included in any of the systems included in the model management system 101. For example, the model selection support apparatus 100 may be included in a system that manages a model catalog.

FIG. 2 is a diagram showing an example of a data structure of the connection system management information 130 according to the first embodiment.

The connection system management information 130 stores an entry including an ID 201, a system name 202, a URL 203, a management type 204, and a publishment type 205. One entry exists for one system of a connection destination.

The ID 201 is a field for storing identification information for identifying an entry of the connection system management information 130. The ID 201 stores, for example, an identification number.

The system name 202 is a field for storing a name for identifying a connection destination system. The system name 202 stores a name of system, a function, an organization, and the like.

The URL 203 is a field for storing a URL for accessing the connection destination system.

The management type 204 is a field for storing the type of information managed by the system of the connection destination.

The publishment type 205 is a field for storing a value indicating whether or not the information managed by the connection destination system is published to the outside. The publishment type 205 stores either “published” or “non-published”.

In the present embodiment, it is assumed that a connection destination system is registered in advance. When the connection destination system is registered, the name of the system, the URL, the type of information to be managed, the type of publishment, and the like are also registered.

FIG. 3 is a diagram showing an example of a data structure of the link management information 131 according to the first embodiment.

The link management information 131 stores an entry including an ID 301, an object name 302, a raw data URL 303, and an outline data URL 304. One entry exists for each object.

The ID 301 is a field for storing identification information for identifying an entry of the link management information 131. The ID 301 stores, for example, an identification number.

The object name 302 is a field for storing a name for identifying the object. The object name 302 stores the name of the object. The field may be a field for storing identification information other than the name of the object.

The raw data URL 303 is a field for storing a URL for accessing a system (storage region) that stores data corresponding to the object itself. The outline data URL 304 is a field for storing a URL for accessing a system (storage region) that stores data representing an outline of the object.

FIG. 4 is a diagram showing an example of a data structure of the lineage management information 132 according to the first embodiment.

The lineage management information 132 includes an entry including an ID 401, a model name 402, a phase 403, a source 404, and a destination 405. One entry exists for each pair of objects that constitutes the model lineage.

The ID 401 is a field for storing identification information for identifying an entry of the lineage management information 132. The ID 401 stores, for example, an identification number.

The model name 402 is a field for storing a name of the model.

The phase 403 is a field for storing information indicating a phase of a model generation process. In the phase of the model generation process, a learning phase and a verification phase exist. The verification phase includes a verification phase corresponding to verification performed by a provider of the model, and a verification phase corresponding to verification performed by the user who uses the model. In the first embodiment, only the verification performed by the provider of the model is targeted. The verification performed by the user will be described in a third embodiment.

The source 404 is a field for storing identification information of an object serving as a source of a pair indicating relevance of objects. The destination 405 is a field for storing identification information of an object serving as a destination of the pair indicating the relevance of the objects.

FIG. 5 is a diagram showing an example of a data structure of the transparency score management information 133 according to the first embodiment.

The transparency score management information 133 is information in a matrix format. One row exists for each combination of score type and item, and one column exists for each model. A score is stored in a cell of the matrix.

Here, the score type indicates an evaluation layer of the model generation process. In the present embodiment, the model generation process is divided into a plurality of evaluation layers (data source, feature extraction, model generation, model verification), and a score is set for each evaluation layer. A plurality of items to be evaluated are included in each evaluation layer.

FIG. 6 is a flowchart illustrating an example of data collection processing executed by the model selection support apparatus 100 according to the first embodiment.

The model selection support apparatus 100 executes the data collection processing when a data collection instruction is received, when an entry is added to the connection system management information 130, or when the model selection support apparatus 100 is activated. A trigger for executing the processing of the data collection unit 120 is an example, and the invention is not limited thereto.

The data collection unit 120 accesses the system based on the connection system management information 130, and acquires various kinds of catalog information (step S101).

The acquired catalog information includes catalog information of input data, catalog information of an ETL program, catalog information of a model, catalog information of verification data, catalog information of a verification program, catalog information of a verification result, and the like.

The data collection unit 120 generates the link management information 131 based on the catalog information (step S102).

For example, the data collection unit 120 adds an entry whose object name 302 is “Learning data” based on the catalog information of the input data.

The data collection unit 120 acquires a model lineage from the model management system 101 (step S103).

The data collection unit 120 generates the lineage management information 132 based on the acquired model lineage (step S104). Thereafter, the data collection unit 120 ends the data collection processing.

Specifically, the data collection unit 120 forms a pair of objects based on the model lineage, and adds one entry corresponding to each pair to the lineage management information 132. The evaluation layer of the model generation process may include information related to the evaluation layer in the model lineage. The data collection unit 120 may also determine the evaluation layer of the model generation process based on the name of the object.

When the model management system 101 and the like manage link information and lineage, the data collection unit 120 is only required to collect such information. That is, the data collection unit 120 may not generate the link management information 131 and the linear management information 132.

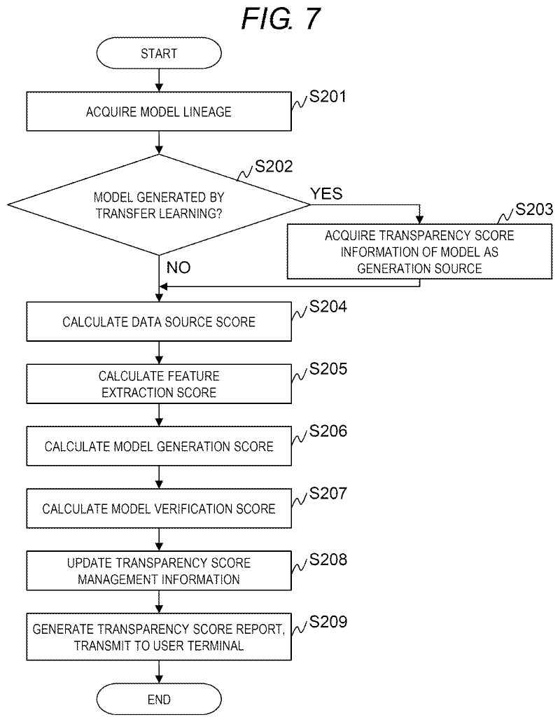

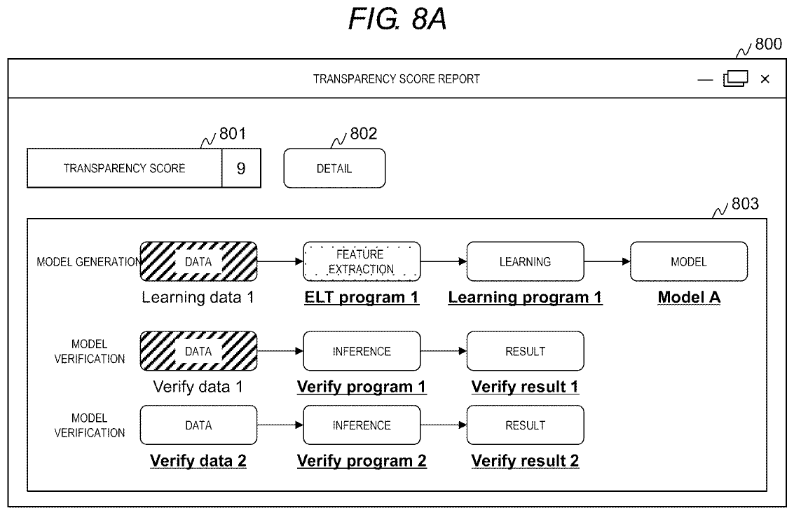

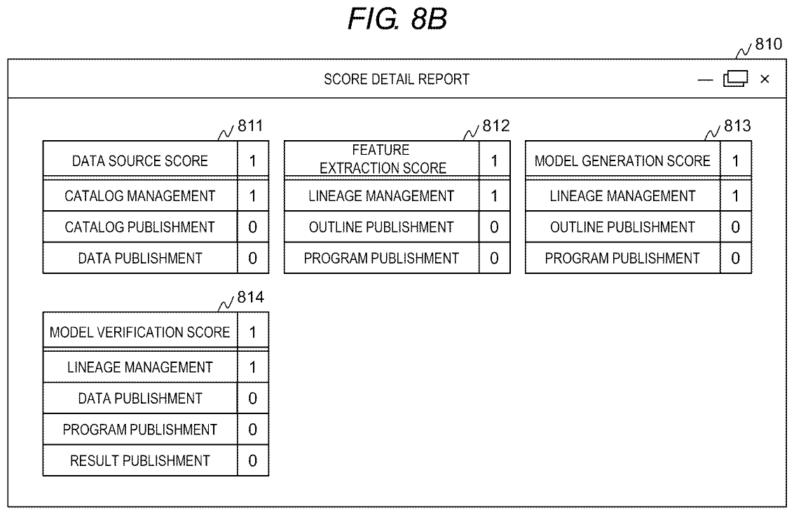

FIG. 7 is a flowchart illustrating an example of transparency score report generation processing executed by the model selection support apparatus 100 according to the first embodiment. FIGS. 8A and 8B are diagrams illustrating examples of screens presented by the model selection support apparatus 100 according to the first embodiment.

When receiving a score calculation instruction from the user terminal 102, the model selection support apparatus 100 executes the transparency score report generation processing. The score calculation instruction includes information of the model to be evaluated. In FIG. 7, processing performed on one model will be described. When a plurality of models are designated, the same processing is executed for each model. In the following description, the model to be evaluated is referred to as a target model.

The transparency score calculation unit 121 acquires lineage of the target model from the lineage management information 132 (step S201).

Specifically, the transparency score calculation unit 121 acquires an entry group in which the name of the target model is stored in the model name 402.

Next, the transparency score calculation unit 121 determines whether or not the target model is a model generated by transfer learning (step S202).

Specifically, the transparency score calculation unit 121 determines whether or not the acquired entry group includes an entry whose phase 403 is “learning” and whose source 404 is the name of a model. When there is an entry that satisfies the above-described condition, the transparency score calculation unit 121 determines that the target model is a model generated by the transfer learning.

When it is determined that the target model is not a model generated by the transfer learning, the transparency score calculation unit 121 moves to step S204.

When it is determined that the target model is a model generated by the transfer learning, the transparency score calculation unit 121 acquires generation source model transparency score information from the transparency score management information 133 (step S203), and then moves the processing to step S204.

Specifically, the transparency score calculation unit 121 acquires a column corresponding to the target model.

From step S204 to step S207, the traceability is analyzed for each evaluation layer of the model generation process, and a score of each evaluation layer is calculated.

First, the transparency score calculation unit 121 calculates a data source score (step S204). Specifically, the following processing is executed.

(S204-1) The transparency score calculation unit 121 determines whether or not the input data is managed as a catalog.

Specifically, the transparency score calculation unit 121 refers to the link management information 131 based on the identification information of the input data, and acquires a link of the input data (raw data URL 303). The transparency score calculation unit 121 makes an inquiry including a link to the model management system 101, and determines whether or not the input data is managed as a catalog based on a response to the inquiry.

(S204-2) The transparency score calculation unit 121 calculates “1” as a score when the input data is managed as a catalog, and calculates “0” as a score when the input data is not managed as a catalog. The values of the score are an example, and are not limited thereto.

(S204-3) The transparency score calculation unit 121 determines whether or not the catalog of the input data is published.

Specifically, the transparency score calculation unit 121 transmits an access request including a link to the model management system 101, and determines whether or not the catalog of the input data is published based on a response to the access request. For example, when the access request is certified and an HTTP response is 200 series, the transparency score calculation unit 121 determines that the catalog of the input data is published.

(S204-4) The transparency score calculation unit 121 calculates “1” as the score when the catalog of the input data is published, and calculates “0” as the score when the catalog of the input data is not published. The values of the score are an example, and are not limited thereto.

(S204-5) The transparency score calculation unit 121 determines whether or not the input data is published.

Specifically, the transparency score calculation unit 121 specifies a system that stores the input data based on the link of the input data, and determines whether or not the publishment type 205 of the entry corresponding to the identified system is “published”. When the publishment type 205 is “non-published”, the transparency score calculation unit 121 determines that the input data is not published. When the publishment type 205 is “published”, the transparency score calculation unit 121 transmits an access request including a link to the system, and determines whether or not the input data is published based on a response to the access request. For example, when the access request is certified and the HTTP response is 200 series, the transparency score calculation unit 121 determines that the input data is published.

(S204-6) The transparency score calculation unit 121 calculates “1” as the score when the input data is published, and calculates “0” as the score when the input data is not published. The values of the score are an example, and are not limited thereto.

The above is the description of the processing in step S204.

Next, the transparency score calculation unit 121 calculates a feature extraction score (step S205). Specifically, the following processing is executed.

(S205-1) The transparency score calculation unit 121 determines whether or not a pair of the input data and the ETL program is included in the model lineage. That is, it is determined whether the input data is traceable.

(S205-2) The transparency score calculation unit 121 calculates “1” as the score when a pair of the input data and the ETL program is included in the model lineage, and calculates “0” as the score when no pairs of the input data and the ETL program are not included in the model lineage.

The values of the score are an example, and are not limited thereto. When the target model is a model generated based on the transfer learning, the transparency score calculation unit 121 adds a value obtained by multiplying the score related to the lineage in a generation source model by a weight to the above described score.

(S205-3) The transparency score calculation unit 121 determines whether or not an outline of the ETL program is published.

Specifically, the transparency score calculation unit 121 refers to the link management information 131 based on the identification information of the ETL program, and acquires a link of the outline of the ETL program (outline data URL 304). The transparency score calculation unit 121 specifies a system that stores the outline of the ETL program based on the link of the outline of the ETL program, and determines whether or not the publishment type 205 of the entry corresponding to the specified system is “published”. When the publishment type 205 is “non-published”, the transparency score calculation unit 121 determines that the outline of the ETL program is not published. When the publishment type 205 is “published”, the transparency score calculation unit 121 transmits an access request including a link to the system, and determines whether or not the outline of the ETL program is published based on a response to the access request. For example, when the access request is certified and the HTTP response is 200 series, the transparency score calculation unit 121 determines that the outline of the ETL program is published.

(S205-4) The transparency score calculation unit 121 calculates “1” as the score when the outline of the ETL program is published, and calculates “0” as the score when the outline of the ETL program is not published.

The values of the score are an example, and are not limited thereto. When the target model is a model generated based on transfer learning, the transparency score calculation unit 121 adds a value obtained by multiplying the score related to the outline of the ETL program in the generation source model by a weight to the above described score.

(S205-5) The transparency score calculation unit 121 determines whether or not the ETL program is published.

Specifically, the transparency score calculation unit 121 refers to the link management information 131 based on the identification information of the ETL program, and acquires a link of the ETL program (raw data URL 303). The transparency score calculation unit 121 specifies a system that stores the ETL program based on the link of the ETL program, and determines whether or not the publishment type 205 of the entry corresponding to the specified system is “published”. When the publishment type 205 is “non-published”, the transparency score calculation unit 121 determines that the ETL program is not published. When the publishment type 205 is “published”, the transparency score calculation unit 121 transmits an access request including a link to the system, and determines whether or not the ETL program is published based on a response to the access request. For example, when the access request is certified and the HTTP response is 200 series, the transparency score calculation unit 121 determines that the ETL program is published.

(S205-6) The transparency score calculation unit 121 calculates “1” as the score when the ETL program is published, and calculates “0” as the score when the ETL program is not published.

The values of the score are an example, and are not limited thereto. When the target model is a model generated based on transfer learning, the transparency score calculation unit 121 adds a value obtained by multiplying the score related to the ETL program in the generation source model by a weight to the above described score.

The above is the description of the processing in step S205.

Next, the transparency score calculation unit 121 calculates a model generation score (step S206). Specifically, the following processing is executed.

(S206-1) The transparency score calculation unit 121 determines whether or not a pair of an ETL program and a learning program are included in the model lineage. That is, it is determined whether or not the feature is traceable.

(S206-2) The transparency score calculation unit 121 calculates “1” as the score when the pair of the ETL program and the learning program is included in the model lineage, and calculates “0” as the score when no pairs of the ETL program and the learning program are included in the model lineage.

The values of the score are an example, and are not limited thereto. When the target model is a model generated based on the transfer learning, the transparency score calculation unit 121 adds a value obtained by multiplying the score related to the lineage in the generation source model by a weight to the above-mentioned score.

(S206-3) The transparency score calculation unit 121 determines whether the outline of the learning program is published.

Specifically, the transparency score calculation unit 121 refers to the link management information 131 based on the identification information of the learning program, and acquires a link of the outline of the learning program (outline data URL 304). The transparency score calculation unit 121 specifies a system that stores the outline of the learning program based on the link of the outline of the learning program, and determines whether or not the publishment type 205 of the entry corresponding to the specified system is “published”. When the publishment type 205 is “non-published”, the transparency score calculation unit 121 determines that the outline of the learning program is not published. When the publishment type 205 is “published”, the transparency score calculation unit 121 transmits an access request including a link to the system, and determines whether the outline of the learning program is published based on a response to the access request. For example, when the access request is certified and the HTTP response is 200 series, the transparency score calculation unit 121 determines that the outline of the learning program is published.

(S206-4) The transparency score calculation unit 121 calculates “1” as the score when the outline of the learning program is published, and calculates “0” as the score when the outline of the learning program is not published.

The values of the score are an example, and are not limited thereto. When the target model is a model generated based on transfer learning, the transparency score calculation unit 121 adds a value obtained by multiplying the score related to the outline of the learning program in the generation source model by a weight to the above described score.

(S206-5) The transparency score calculation unit 121 determines whether or not the learning program is published.

Specifically, the transparency score calculation unit 121 refers to the link management information 131 based on the identification information of the learning program, and acquires a link of the learning program (raw data URL 303). The transparency score calculation unit 121 specifies a system that stores the learning program based on the link of the learning program, and determines whether or not the publishment type 205 of the entry corresponding to the specified system is “published”. When the publishment type 205 is “non-published”, the transparency score calculation unit 121 determines that the learning program is not published. When the publishment type 205 is “published”, the transparency score calculation unit 121 transmits an access request including a link to the system, and determines whether or not the learning program is published based on a response to the access request. For example, when the access request is certified and the HTTP response is 200 series, the transparency score calculation unit 121 determines that the learning program is published.

(S206-6) The transparency score calculation unit 121 calculates “1” as the score when the learning program is published, and calculates “0” as the score when the learning program is not published.

The values of the score are an example, and are not limited thereto. When the target model is a model generated based on transfer learning, the transparency score calculation unit 121 adds a value obtained by multiplying the score related to the learning program in the generation source model by a weight to the above described score.

The above is the description of the processing of step S206.

Next, the transparency score calculation unit 121 calculates a model verification score (step S207). Specifically, the following processing is executed.

(S207-1) The transparency score calculation unit 121 determines whether or not a pair of a verification program and a verification result is included in the model lineage. That is, it is determined whether or not the model verification is traceable.

(S207-2) The transparency score calculation unit 121 calculates “1” as the score when the pair of the verification program and the verification result is included in the model lineage, and calculates “0” as the score when no pairs of the verification program and the verification result are included in the model lineage.

The values of the score are an example, and are not limited thereto. When the target model is a model generated based on the transfer learning, the transparency score calculation unit 121 adds a value obtained by multiplying the score related to the lineage in the generation source model by a weight to the above described score. When the verification is performed a plurality of times, the transparency score calculation unit 121 calculates a statistical value of the score for each verification as a score of an evaluation item.

(S207-3) The transparency score calculation unit 121 determines whether or not the outline of the verification result is published.

Specifically, the transparency score calculation unit 121 refers to the link management information 131 based on the identification information of the verification result, and acquires a link of an outline of the verification result (outline data URL 304). The transparency score calculation unit 121 specifies a system that stores the outline of the verification result based on the information of a link destination of the outline of the verification result, and determines whether or not the publishment type 205 of the entry corresponding to the specified system is “published”. When the publishment type 205 is “non-published”, the transparency score calculation unit 121 determines that the outline of the verification result is not published. When the publishment type 205 is “published”, the transparency score calculation unit 121 transmits an access request including a link to the system, and determines whether or not the outline of the verification result is published based on a response to the access request. For example, when the access request is certified and an HTTP response is 200 series, the transparency score calculation unit 121 determines that the outline of the verification result is published.

(S207-4) The transparency score calculation unit 121 calculates “1” as the score when the outline of the verification result is published, and calculates “0” as the score when the outline of the verification result is not published.

The values of the score are an example, and are not limited thereto. When the target model is a model generated based on transfer learning, the transparency score calculation unit 121 adds a value obtained by multiplying the score related to the outline of the verification result in the generation source model by a weight to the above described score. When the verification is performed a plurality of times, the transparency score calculation unit 121 calculates a statistical value of the score for each verification as a score of an evaluation item.

(S207-5) The transparency score calculation unit 121 determines whether or not the verification program is published.

Specifically, the transparency score calculation unit 121 refers to the link management information 131 based on the identification information of the verification program, and acquires a link of the verification program (raw data URL 303). The transparency score calculation unit 121 specifies a system that stores the verification program based on the link of the verification program, and determines whether or not the publishment type 205 of the entry corresponding to the specified system is “published”. When the publishment type 205 is “non-published”, the transparency score calculation unit 121 determines that the verification program is not published. When the publishment type 205 is “published”, the transparency score calculation unit 121 transmits an access request including a link to the system, and determines whether or not the verification program is published based on a response to the access request. For example, when the access request is certified and the HTTP response is 200 series, the transparency score calculation unit 121 determines that the verification program is published.

(S207-6) The transparency score calculation unit 121 calculates “1” as the score when the verification program is published, and calculates “0” as the score when the verification program is not published.

The values of the score are an example, and are not limited thereto. When the target model is a model generated based on transfer learning, the transparency score calculation unit 121 adds a value obtained by multiplying the score related to the verification program in the generation source model by a weight to the above described score. When the verification is performed a plurality of times, the transparency score calculation unit 121 calculates a statistical value of the score for each verification as a score of an evaluation item.

(S207-7) The transparency score calculation unit 121 determines whether or not the verification result is published.

Specifically, the transparency score calculation unit 121 refers to the link management information 131 based on the identification information of the verification result, and acquires a link of the verification result (raw data URL 303). The transparency score calculation unit 121 specifies a system that stores the verification result based on the link of the verification result, and determines whether or not the publishment type 205 of the entry corresponding to the specified system is “published”. When the publishment type 205 is “non-published”, the transparency score calculation unit 121 determines that the verification result is not published. When the publishment type 205 is “published”, the transparency score calculation unit 121 transmits an access request including a link to the system, and determines whether or not the verification result is published based on a response to the access request. For example, when the access request is certified and the HTTP response is 200 series, the transparency score calculation unit 121 determines that the verification result is published.

(S207-8) The transparency score calculation unit 121 calculates “1” as the score when the verification result is published, and calculates “0” as the score when the verification result is not published.

The values of the score are an example, and are not limited thereto. When the target model is a model generated based on transfer learning, the transparency score calculation unit 121 adds a value obtained by multiplying the score related to the verification result in the generation source model by a weight to the above described score. When the verification is performed a plurality of times, the transparency score calculation unit 121 calculates a statistical value of the score for each verification as a score of an evaluation item.

The above is the description of the processing in step S207.

Next, the transparency score calculation unit 121 updates the transparency score management information 133 (step S208).

Specifically, the transparency score calculation unit 121 adds a target model column to the transparency score management information 133. The transparency score calculation unit 121 sets the score calculated from step S204 to step S207 in each cell of the added column.

At this time, the transparency score calculation unit 121 calculates a total value of the data source score, the feature extraction score, the model generation score, and the model verification score as a transparency score and stores the transparency score in the work area.

Next, the report generation unit 122 generates a transparency score report and transmits the transparency score report to the user terminal 102 (step S209). Thereafter, the model selection support apparatus 100 ends the transparency score report generation processing. In step S209, the following processing is executed.

(S209-1) The report generation unit 122 specifies objects based on the lineage of the target model, and generates graphs in which each node is a specified object. The report generation unit 122 determines a color of a node based on the publishment type of the object corresponding to the node. In addition, the report generation unit 122 embeds a link to the published object in the node.

A color of the node when the object itself is published and a color of the node when the outline of the object is published are determined differently.

(S209-4) The report generation unit 122 generates display information for displaying the graph and the transparency scores. The report generation unit 122 generates display information for displaying the data source score, the feature extraction score, the model generation score, and the model verification score.

(S209-5) The report generation unit 122 transmits the display information as a transparency score report.

The above is the description of the processing in step S209.

When the target model column exists in the transparency score management information 133, the processing from step S201 to step S208 is not executed. In this case, only the processing of step S209 is executed.

Next, a screen displayed on the user terminal 102 that receives the transparency score report will be described. Screens as shown in FIGS. 8A and 8B are displayed on the user terminal 102.

A screen 800 includes a transparency score display field 801, a detail button 802, and a graph display field 803.

The transparency score display field 801 is a field for displaying a transparency score. The detail button 802 is an operation button for referring to the score of each evaluation layer of the model generation process. When the user displays the detail button 802, a screen 810 is displayed.

The graph display field 803 is a field for displaying graphs in which each node is an object. In FIG. 8A, one graph is generated for each phase of the model generation process. Shaded nodes indicate that the object is not published, dotted nodes indicate that only the outline of the object is published, and white nodes indicate that the object is published. In addition, names of the objects are displayed at the nodes. Underlined names indicate that a link for accessing the object is embedded. When the user operates the name, an access request to the object or the outline of the object is transmitted to the system via the model selection support apparatus 100. The user can confirm details of the object via the screen 800.

The screen 810 includes a data source score field 811, a feature extraction score field 812, a model generation score field 813, and a model verification score field 814.

The data source score field 811 is a field for displaying the score of each evaluation item of the data source score. The feature extraction score field 812 is a field for displaying the score of each evaluation item of the feature extraction score. The model generation score field 813 is a field for displaying the score of each evaluation item of the model generation score. The model verification score field 814 is a field for displaying the score of each evaluation item of the model verification score.

The screen 800 may include the data source score field 811, the feature extraction score field 812, the model generation score field 813, and the model verification score field 814 instead of the detail button 802.

The model selection support apparatus 100 may store a copy of information to be referred to at the time of calculating the score in the storage device 112 or the like. Accordingly, various kinds of information can be quickly presented to the user without accessing the model management system 101 or the like.

The user may set a threshold value of the transparency score in the model selection support apparatus 100 instead of designating the model. In this case, the model selection support apparatus 100 calculates each model transparency score, and searches for a model having the transparency score larger than the threshold value.

According to the first embodiment, the model selection support apparatus 100 can present the transparency score as quantitative information for evaluating the model transparency. Further, the model selection support apparatus 100 can present data and programs used in the model generation process, and processing results. Accordingly, the user can easily select a model having required transparency, that is, a reliable model.

### Second Embodiment

Ina second embodiment, a score calculated from a viewpoint different from that of the first embodiment is introduced. Hereinafter, the second embodiment will be described focusing on differences from the first embodiment.

A configuration of the computer system according to the second embodiment is the same as that of the first embodiment. A hardware configuration and a software configuration of the model selection support apparatus 100 according to the second embodiment are the same as those of the first embodiment. However, in the second embodiment, contents of the transparency score management information 133 is partially different.

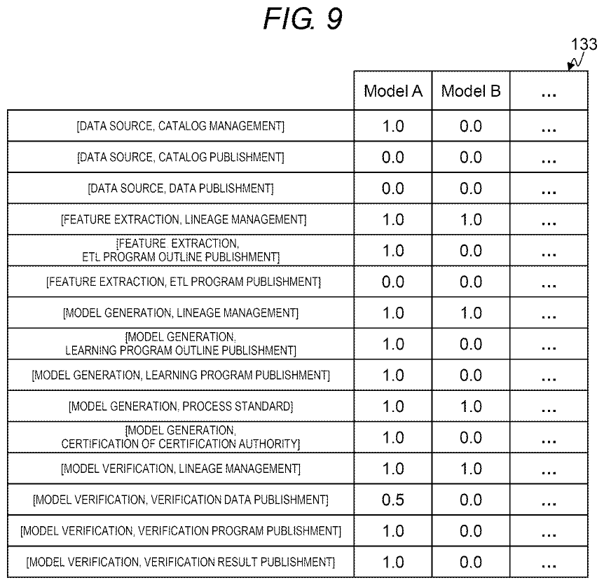

FIG. 9 is a diagram showing an example of a data structure of the transparency score management information 133 according to the first embodiment according to the second embodiment.

The structure of the transparency score management information 133 according to the second embodiment is the same as that of the first embodiment. In the second embodiment, a score of a new evaluation item is added to the evaluation layer of model generation. Specifically, a score indicating whether or not a generation process complies with a predetermined standard and a score indicating whether or not a model is certified by a certification authority are added.

In the second embodiment, the processing of step S206 of the transparency score report generation processing is partially different. Specifically, the following processing is added.

(S206-7) The transparency score calculation unit 121 determines whether or not the model generation process complies with a predetermined standard. For example, the transparency score calculation unit 121 acquires information related to a standard or the like adopted from the model management system 101, and determines whether or not the model generation process complies with the predetermined standard. The information necessary for the determination may be acquired in step S201.

(S206-8) The transparency score calculation unit 121 calculates “1” as a score when the model generation process complies with the predetermined standard, and calculates “0” as a score when the model generation process does not comply with the predetermined standard.

The values of the score are an example, and are not limited thereto. When a target model is a model generated based on transfer learning, the transparency score calculation unit 121 adds a value obtained by multiplying the score related to the standard in the generation source model by a weight to the above described score.

(S206-9) The transparency score calculation unit 121 determines whether or not the target model is certified by the certification authority. For example, the transparency score calculation unit 121 determines whether or not the target model is certified by the certification authority by making an inquiry that includes the identification information of the target model to the certification authority. The information necessary for the determination may be acquired in step S201.

(S206-10) The transparency score calculation unit 121 calculates “1” as the score when the target model is certified by the certification authority, and calculates “0” as the score when the target model is not certified by the certification authority.

The values of the score are an example, and are not limited thereto. When the target model is a model generated based on the transfer learning, the transparency score calculation unit 121 adds a value obtained by multiplying the score related to the certification in the generation source model by a weight to the above described score.

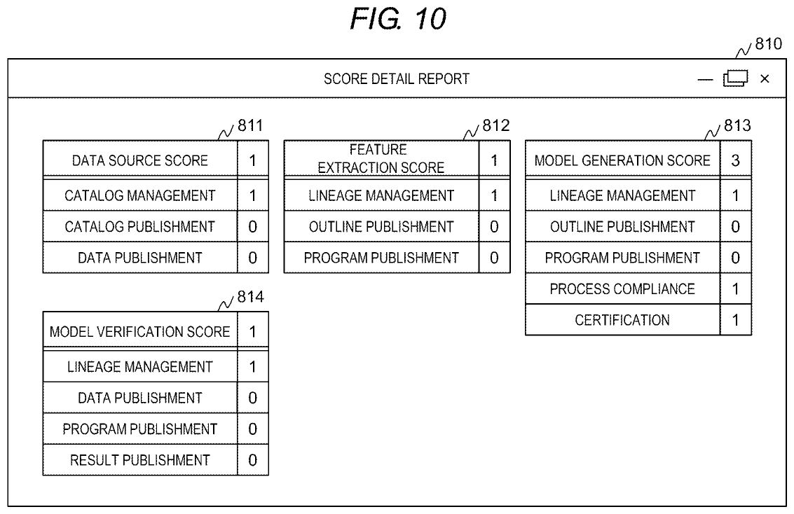

In the second embodiment, a screen for presenting details of the score is partially different. FIG. 10 is a diagram showing an example of a screen presented by the model selection support apparatus 100 according to the second embodiment. In the screen 810 according to the second embodiment, scores of evaluation items for process compliance and certification are added to the model generation score field 813.

According to the second embodiment, a more effective transparency score can be presented by adding a score in consideration of the standard and the certification by a third party.

### Third Embodiment

In a third embodiment, a transparency score is updated based on verification performed by a user who uses a model. Hereinafter, the third embodiment will be described focusing on differences from the first embodiment.

A configuration of the computer system according to the third embodiment is the same as that of the first embodiment. A hardware configuration and a software configuration of the model selection support apparatus 100 according to the third embodiment are the same as those of the first embodiment.

In the third embodiment, information stored in the connection system management information 130, the link management information 131, the lineage management information 132, and the transparency score management information 133 is different. The connection system management information 130 stores information related to the system that the user performs the verification. In addition, the link management information 131 stores a link to data and programs and a verification result used in the verification performed by the user.

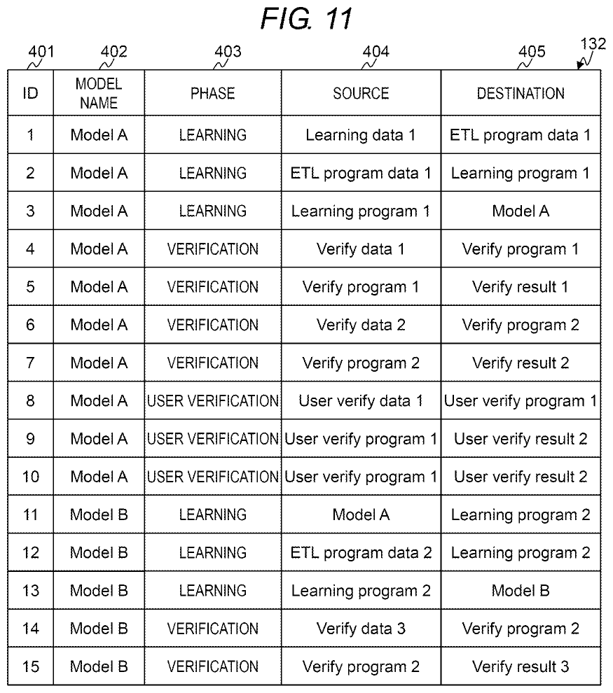

The lineage management information 132 stores a lineage of a verification process performed by the user. FIG. 11 is a diagram showing an example of a data structure of the lineage management information 132 according to the third embodiment.

In the lineage management information 132, entries whose phase 403 is “user verification” are added. These entries indicate the lineage of the verification process performed by the user.

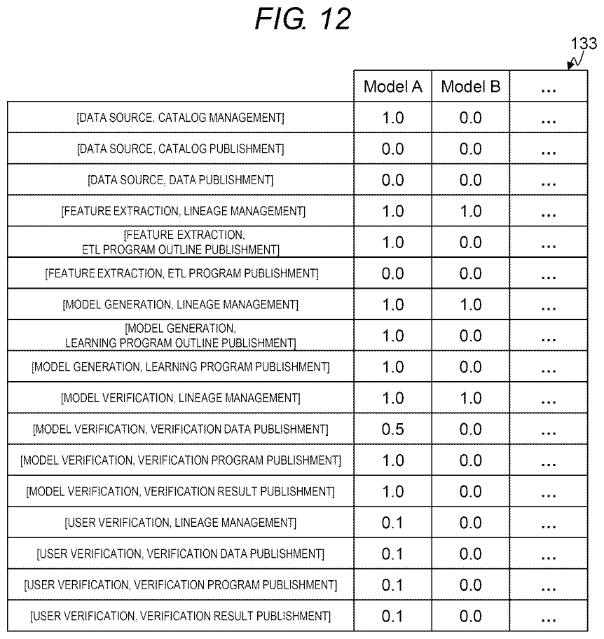

Further, in the third embodiment, contents of the transparency score management information 133 are partially different. FIG. 12 is a diagram showing an example of a data structure of the transparency score management information 133 according to the first embodiment according to the third embodiment.

The structure of the transparency score management information 133 according to the third embodiment is the same as that of the first embodiment. In the third embodiment, a score using the verification performed by the user as an evaluation layer is added.

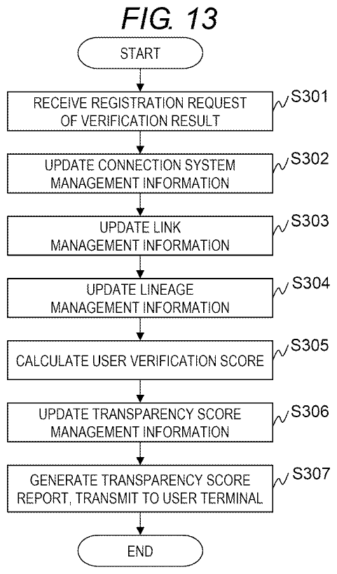

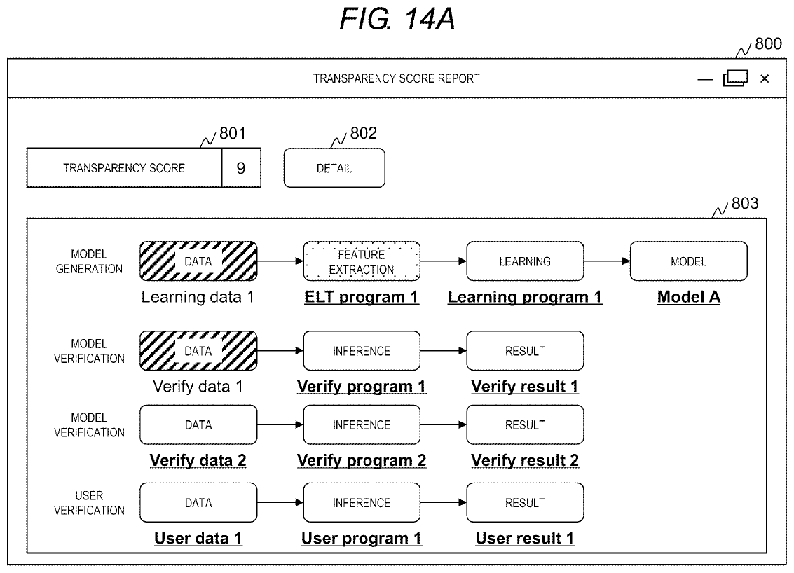

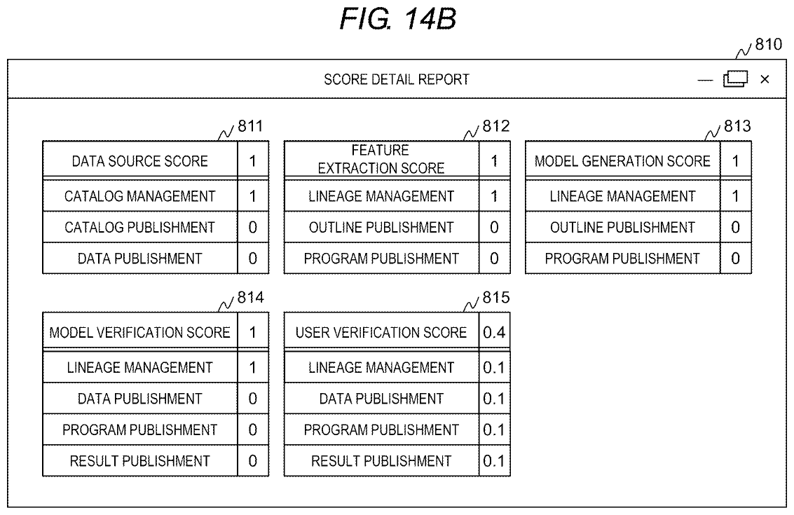

FIG. 13 is a flowchart illustrating an example of transparency score update processing executed by the model selection support apparatus 100 according to the third embodiment. FIGS. 14A and 14B are diagrams illustrating examples of screens presented by the model selection support apparatus 100 according to the third embodiment.

The model selection support apparatus 100 receives a registration request of a verification result from the user terminal 102 (step S301).

Upload of the verification result can be implemented, for example, by providing an input field on the screen 800. The registration request of the verification result includes lineage of the verification process, links for accessing data and programs used in the verification process and verification results, and a publishment type.

The data collection unit 120 updates the connection system management information 130, the link management information 131, and the lineage management information 132 based on the information included in the registration request of the verification result (step S302, step S303, and step S304).

Next, the transparency score calculation unit 121 calculates a user verification score (step S305). Specifically, the following processing is executed.

(S305-1) The transparency score calculation unit 121 determines whether or not the lineage of the verification process is received. That is, it is determined whether or not the verification process performed by the user is traceable.

(S305-2) The transparency score calculation unit 121 calculates “0.1” as the score when the lineage of the verification process is received, and calculates “0” as the score when the lineage of the verification process is not received. The transparency score calculation unit 121 refers to the transparency score management information 133, and acquires a value of a cell in which a combination of the score type and the item is “user verification, lineage management” from a column corresponding to the target model. The transparency score calculation unit 121 adds the calculated score to the acquired value. When the value is larger than 1, the transparency score calculation unit 121 corrects the value to 1. The above is processing for preventing the score from exceeding a maximum value.

(S305-3) The transparency score calculation unit 121 determines whether or not the verification data is published.

Specifically, the transparency score calculation unit 121 refers to the link management information 131 based on the identification information of the verification data, and acquires a link of the verification data (raw data URL 303). The transparency score calculation unit 121 specifies a system that stores the verification data based on the link of the verification data, and determines whether or not the publishment type 205 of the entry corresponding to the specified system is “published”. When the publishment type 205 is “non-published”, the transparency score calculation unit 121 determines that the verification data is not published. When the publishment type 205 is “published”, the transparency score calculation unit 121 transmits an access request including a link to the system, and determines whether or not the verification data is published based on a response to the access request. For example, when the access request is certified and the HTTP response is 200 series, the transparency score calculation unit 121 determines that the verification data is published.

(S305-4) The transparency score calculation unit 121 calculates “0.1” as the score when the verification data is published, and calculates “0” as the score when the verification data is not published. The transparency score calculation unit 121 refers to the transparency score management information 133, and acquires a value of a cell in which a combination of the score type and the item is “user verification, verification data publishment” from a column corresponding to the target model. The transparency score calculation unit 121 adds the calculated score to the acquired value. When the value is larger than 1, the transparency score calculation unit 121 corrects the value to 1. The above is processing for preventing the score from exceeding the maximum value.

(S305-5) The transparency score calculation unit 121 determines whether or not the verification program is published.

Specifically, the transparency score calculation unit 121 refers to the link management information 131 based on the identification information of the verification program, and acquires a link of the verification program (raw data URL 303). The transparency score calculation unit 121 specifies a system that stores the verification program based on the link of the verification program, and determines whether or not the publishment type 205 of the entry corresponding to the specified system is “published”. When the publishment type 205 is “non-published”, the transparency score calculation unit 121 determines that the verification program is not published. When the publishment type 205 is “published”, the transparency score calculation unit 121 transmits an access request including a link to the system, and determines whether or not the verification program is published based on a response to the access request. For example, when the access request is certified and the HTTP response is 200 series, the transparency score calculation unit 121 determines that the verification program is published.

(S305-6) The transparency score calculation unit 121 calculates “0.1” as the score when the verification program is published, and calculates “0” as the score when the verification program is not published. The transparency score calculation unit 121 refers to the transparency score management information 133, and acquires a value of a cell in which a combination of the score type and the item is “user verification, verification program publishment” from a column corresponding to the target model. The transparency score calculation unit 121 adds the calculated score to the acquired value. When the value is larger than 1, the transparency score calculation unit 121 corrects the value to 1. The above is processing for preventing the score from exceeding a maximum value.

(S305-7) The transparency score calculation unit 121 determines whether or not the verification result is published.

Specifically, the transparency score calculation unit 121 refers to the link management information 131 based on the identification information of the verification result, and acquires a link of the verification result (raw data URL 303). The transparency score calculation unit 121 specifies a system that stores the verification result based on the link of the verification result, and determines whether or not the publishment type 205 of the entry corresponding to the specified system is “published”. When the publishment type 205 is “non-published”, the transparency score calculation unit 121 determines that the verification result is not published. When the publishment type 205 is “published”, the transparency score calculation unit 121 transmits an access request including a link to the system, and determines whether or not the verification result is published based on a response to the access request. For example, when the access request is certified and the HTTP response is 200 series, the transparency score calculation unit 121 determines that the verification result is published.

(S305-8) The transparency score calculation unit 121 calculates “0.1” as the score when the verification result is published, and calculates “0” as the score when the verification result is not published. The transparency score calculation unit 121 refers to the transparency score management information 133, and acquires a value of a cell in which a combination of the score type and the item is “user verification, verification result publishment” from a column corresponding to the target model. The transparency score calculation unit 121 adds the calculated score to the acquired value. When the value is larger than 1, the transparency score calculation unit 121 corrects the value to 1. The above is processing for preventing the score from exceeding a maximum value.

The above is the description of the processing of step S305.

Next, the transparency score calculation unit 121 updates the transparency score management information 133 (step S306).

Specifically, the transparency score calculation unit 121 sets the score calculated in step S305 to each cell corresponding to the user verification of the target model column of the transparency score management information 133.

Next, the report generation unit 122 generates a transparency score report and transmits the transparency score report to the user terminal 102 (step S307). Thereafter, the model selection support apparatus 100 ends the transparency score report generation processing.

The processing of step S307 is the same as the processing of step S209, and a description thereof will be omitted.

As shown in FIG. 14A, a configuration of the screen 800 according to the third embodiment is the same as that of the first embodiment. However, graphs showing the user verification process are displayed in the graph display field 803. When the verification by the user is performed a plurality of times, graphs of each verification are displayed in the graph display field 803.

As shown in FIG. 14B, the screen 810 according to the third embodiment includes a user verification score field 815. The user verification score field 815 is a field for displaying the score of each evaluation item of the user verification score.

According to the third embodiment, a more effective transparency score can be presented by adding a score in consideration of the evaluation of the user.

### (Modification)

A history of a calculation result of a score may be managed. In this case, a row for storing a time stamp is added to the transparency score management information 133.

In the transparency score report generation processing, when a column is added to the transparency score management information 133, the transparency score calculation unit 121 stores a current time in the row of the time stamp.

In the transparency score update processing, the transparency score calculation unit 121 newly adds a column of the target model, and copies a value of the column before updating to a cell corresponding to a data source score, a feature extraction score, a model generation score, and a model verification score among cells of the added column. The transparency score calculation unit 121 sets the score calculated in step S305 to a cell corresponding to the user verification score of the added column. The transparency score calculation unit 121 stores the current time in the cell corresponding to the time stamp of the added column.

The model selection support apparatus 100 may manage a history of a transparency score report instead of a history of a score calculation result.

According to the modification according to the third embodiment, the model selection support apparatus 100 can generate a past transparency score report based on the history of the score calculation result. Accordingly, user convenience is expected to be improved.

The invention is not limited to the above-mentioned embodiments, and includes various modifications. For example, the embodiments described above have been described in detail for easy understanding of the present disclosure, and the present disclosure is not necessarily limited to those including all the configurations described above. A part of the configuration of the embodiments may be deleted and may be added and replaced with another configuration.

A portion or all of the configurations, functions, processing units, processing methods or the like described above may be implemented by hardware such as through design using an integrated circuit. The disclosure can also be implemented by program code of software that implements the functions of the embodiments. In this case, a storage medium recording the program code is provided to a computer, and a processor included in the computer reads out the program code stored in the storage medium. In this case, the program code itself read out from the storage medium implements the functions of the above-mentioned embodiments, and the program code itself and the storage medium storing the program code constitute the present disclosure. As a storage medium for supplying such program code, for example, a flexible disk, a CD-ROM, a DVD-ROM, a hard disk, a solid state drive (SSD), an optical disk, a magneto-optical disk, a CD-R, a magnetic tape, a nonvolatile memory card, or a ROM is used.

Further, the program code that implements the functions described in the present embodiment can be implemented in a wide range of programs or script languages such as assembler, C/C++, perl, Shell, PHP, Python, and Java (registered trademark).

Further, the program code of the software that implements the functions of the embodiments may be stored in a storage section such as a hard disk or a memory of a computer or a storage medium such as a CD-RW or a CD-R by delivering via a network, and a processor included in the computer may read out and execute the program code stored in the storage section or the storage medium.

In the embodiments described above, control lines and information lines are considered to be necessary for description, and all control lines and information lines are not necessarily shown in the product. All configurations may be connected to each other.

What is claimed is:

1. A computer system configured to support selection of a model generated by machine learning, the computer system comprising:
at least one computer including a processor and a memory;
a transparency score calculation unit configured to execute analysis processing for analyzing traceability of a generation process of a target model, and calculate a transparency score indicating a degree of the traceability of the generation process of the target model based on a result of the analysis processing of the generation process of the target model; and
a report generation unit configured to generate a report for presenting the transparency score.

2. The computer system according to claim 1, wherein
the analysis processing of the generation process of the target model includes analysis processing of a plurality of evaluation layers obtained by dividing the generation process of the target model, and
the transparency score calculation unit is configured to
calculate first scores of the plurality of evaluation layers based on a result of the analysis processing of each of the plurality of evaluation layers, and
calculate the transparency score based on the plurality of first scores.

3. The computer system according to claim 2, wherein
the computer system is configured to hold lineage management information for managing a lineage of a generation process of each of a plurality of models, and
the analysis processing of at least one of the evaluation layers includes a first analysis processing for analyzing the lineage of the generation process of the target model based on the lineage management information.

4. The computer system according to claim 2, wherein
the analysis processing of at least one of the evaluation layers includes a second analysis processing for determining whether or not data and programs used in the generation process of the target model, and processing results are published.

5. The computer system according to claim 2, wherein
the analysis processing of at least one of the evaluation layers includes a third analysis processing for analyzing a standard used in the generation process of the target model, and a fourth analysis processing for analyzing presence or absence of certification by a certification authority with respect to the target model, and
the transparency score calculation unit is configured to
calculate a second score based on a result of the third analysis processing,
calculate a third score based on a result of the fourth analysis processing, and
calculate the transparency score based on the plurality of first scores, the second score, and the third score.

6. The computer system according to claim 2, wherein
the transparency score calculation unit is configured to:
when information on a verification process of a user who uses the target model with respect to the target model is received from the user, execute analysis processing of a verification process of the user with respect to the target model, and
update the transparency score based on a result of the analysis processing of the verification process of the user, and
the report generation unit is configured to generate a report for presenting the updated transparency score.

7. The computer system according to claim 2, wherein
the computer system is configured to hold transparency score management information for storing data in which identification information of models and the plurality of first scores are associated with each other, and
the transparency score calculation unit is configured to:
when the target model is a model generated by transfer learning, acquire the plurality of first scores of a model to be a generation source of the target model from the transparency score management information and
calculate the transparency score based on the plurality of first scores calculated based on a result of the analysis processing of each of the plurality of evaluation layers with respect to the target model and the plurality of first scores acquired from the transparency score management information.

8. The computer system according to claim 2, wherein
the computer system is configured to hold lineage management information for managing a lineage of a generation process of each of a plurality of models, and
the report generation unit is configured to
specify data and programs used in the generation process of the target model and processing results based on the lineage management information,
generate a graph including nodes representing the specified data, the specified programs, and the specified processing result,
add a link for accessing published data, published programs, and published processing results among the specified data, the specified programs, and the specified processing results to the graph, and
generate and output display information for presenting the transparency score, the plurality of first scores, and the graph.

9. A method for supporting selection of a model generated by machine learning, the method being executed by a computer system including at least one computer including a processor and a memory, the method comprising:
a first step in which the at least one computer executes an analysis process for analyzing traceability of a generation process of the target model, and calculates a transparency score that indicates a degree of the traceability of the generation process of the target model based on a result of the analysis processing of the generation process of the target model; and
a second step in which the at least one computer generates a report for presenting the transparency score.

10. The method for supporting selection of a model according to claim 9, wherein
the analysis processing of the generation process of the target model includes analysis processing of a plurality of evaluation layers obtained by dividing the generation process of the target model, and
the first step includes
a step in which the at least one computer calculates a first score of the plurality of evaluation layers based on a result of the analysis process of each of the plurality of evaluation layers, and
a step in which the at least one computer calculates the transparency score based on the plurality of first scores.

11. The method for supporting selection of a model according to claim 10, wherein
the computer system holds lineage management information for managing a lineage of a generation process of each of a plurality of models, and
the analysis processing of at least one of the evaluation layers includes a first analysis processing for analyzing the lineage of the generation process of the target model based on the lineage management information.

12. The method for supporting selection of a model according to claim 10, wherein
the analysis processing of at least one of the evaluation layers includes a second analysis processing for determining whether or not data and programs used in the generation process of the target model, and processing results are published.

13. The method for supporting selection of a model according to claim 10, further comprising:
a step in which, when information on a verification process of a user who uses the target model with respect to the target model is received from the user, the at least one computer executes analysis processing of the verification process of the user with respect to the target model;
a step in which the at least one computer updates the transparency score based on a result of the analysis processing of the verification process of the user; and
a step in which the at least one computer generates a report for presenting the updated transparency score.

14. The method for supporting selection of a model according to claim 10, wherein
the computer system holds transparency score management information for storing data in which identification information of models and the plurality of first scores are associated with each other, and
the first step includes
a step in which, when the target model is a model generated by transfer learning, the at least one computer acquires the plurality of first scores of a model to be a generation source of the target model from the transparency score management information, and
a step in which the at least one computer calculates the transparency score based on the plurality of first scores calculated based on a result of the analysis processing of each of the plurality of evaluation layers with respect to the target model and the plurality of first scores acquired from the transparency score management information.

15. The method for supporting selection of a model according to claim 10, wherein
the computer system holds lineage management information for managing a lineage of a generation process of each of a plurality of models, and
the second step includes
a step in which the at least one computer specifies data and programs used in the target model generation process and processing results based on the lineage management information,
a step in which the at least one computer generates a graph including nodes representing the specified data, the specified programs, and the specified processing result,
a step in which the at least one computer adds a link for accessing published data, published programs, and published processing results among the specified data, the specified programs, and the specified processing results to the graph, and
a step in which the at least one computer generates and outputs display information for presenting the transparency score, the plurality of first scores, and the graph.
